(19) United States
(12) Patent Application Publication
(10) Pub. No.: US 2018/0374606 A1
(43) Pub. Date: Dec. 27, 2018

(54) WINDING WIRE, WINDING AND METHOD FOR PRODUCING THE WINDING WIRE

(71) Applicant: Delta Electronics (Jiangsu) Ltd., Jiangsu Province (CN)

(72) Inventors: Xiaoxia Yuan, Jiangsu Province (CN); Ming Hsien PENG, Jiangsu Province (CN); Shaodong ZHANG, Jiangsu Province (CN)

(21) Appl. No.: 15/908,826

(22) Filed: Mar. 1, 2018

(30) Foreign Application Priority Data
Jun. 23, 2017 (CN) 201710487958.1

(51) Int. Cl. H01B 7/02; H01B 13/06; H01F 5/00

(52) U.S. Cl. CPC H01B 7/0225; H01F 5/00; H01B 13/06

(57) ABSTRACT

The present application discloses a winding wire, a winding and a method for producing the winding wire. The winding wire comprises a wire and an insulation structure that wraps around the wire. The insulation structure comprises a first insulating layer having a first width and a second insulating layer having a second width, the first width being less than the second width. The second insulating layer has an X-axis direction and a Y-axis direction perpendicular to the X-axis direction, and the first insulating layer is disposed on the second insulating layer in a direction parallel to the X-axis. The wire is disposed, in a direction parallel to the X-axis direction, on the portion of the second insulating layer that is not covered by the first insulating layer, and the first insulating layer and the second insulating layer wrap around the wire in the Y-axis direction.

### CROSS-REFERENCE TO RELATED APPLICATIONS

This non-provisional application claims priority under 35 U.S.C. § 119(a) on Patent Application No. 201710487958.1 filed in P.R. China on Jun. 23, 2017, the entire contents of which are hereby incorporated by reference.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### TECHNICAL FIELD

The present application relates to a winding wire and a method for producing the same; specifically, it particularly relates to a winding wire and a method for producing the same that are not only insulated but also processed automatically.

### BACKGROUND ART

In order to meet the safety requirements, three-layer insulated Kara line is used as winding wire for most of the existing switching mode power supply transformers to meet the insulation requirements. Although this approach meets the safety requirements, the three-layer insulated Kara line costs a lot and is not conducive to reducing production costs; besides, the three-layer insulated Kara line is so hard that, when they are processed into windings, the resultant transformer will occupy too large space, which is not conducive to increasing the power density of the transformer. In summary, if the common three-layer insulated Kara line is used as winding wire, the overall competitiveness of the product will be reduced, so it is urgent to develop a winding wire to overcome the above-mentioned defects and a method for producing the same.

### DISCLOSURE OF THE APPLICATION

The present disclosure provides a winding wire which comprises a wire and an insulation structure, the insulation structure wrapping around the wire, and the insulation structure comprising:

a first insulating layer having a first width; and

a second insulating layer having a second width, wherein the second insulating layer has an X-axis direction and a Y-axis direction perpendicular to the

X-axis direction, the first insulating layer is disposed on the second insulating layer in a direction parallel to the X-axis, the first width is less than the second width, the wire is disposed, in a direction parallel to the X-axis, on the portion of the second insulating layer that is not covered by the first insulating layer, and the first insulating layer and the second insulating layer wrap around the wire in the Y-axis direction.

According to another aspect of the disclosure, a method is provided to produce a coil, comprising:

disposing a first insulating layer on a second insulating layer in an X-axis direction, wherein the first insulating layer haves a first width, the second insulating layer haves a second width, and the first width is less than the second width;

disposing a wire, in a direction parallel to the X-axis, on the portion of the second insulating layer that is not covered by the first insulating layer; and

wrapping around the wire with the first insulating layer and the second insulating layer in a Y-axis direction perpendicular to the X-axis direction.

According to another aspect of the present disclosure, a winding wire is provided, which comprises a wire and a first insulating layer, the first insulating layer having an X-axis direction and a Y-axis direction perpendicular to the X-axis direction, the wire being disposed on the first insulating layer in the X-axis direction, and the first insulating layer wrapping around the wire in the Y-axis direction.

Another aspect of the disclosure is to provide a winding of a magnetic element, comprising the winding wire as described above.

### BRIEF DESCRIPTION OF THE DRAWINGS

FIG. 1 is a top view of the structure of the winding wire provided by an embodiment of the present application;

FIG. 2 is a side view of the structure of the winding wire provided by an embodiment of the present application;

FIG. 3 is a top view of the structure of the winding wire provided by another embodiment of the present application;

FIG. 4 is a side view of the structure of the winding wire provided by another embodiment of the present application;

FIG. 5 is a flow chart of a method for producing the winding wire in FIG. 1;

FIG. 6 is a step-by-step flow chart of step S12 in FIG. 5;

FIG. 7 is a flow chart of a method for producing the winding wire in FIG. 3;

FIG. 8 is a top view of the structure of the winding wire provided by yet another embodiment of the present application;

FIG. 9 is a sectional view of the winding wire shown in FIG. 1;

FIG. 10 is a sectional view of the winding wire shown in FIG. 8.

### EMBODIMENTS

Reference will be made in detail to the accompanying drawings and embodiments of the present application. The embodiments were carried out on the premise of the technical solutions of the present application, and methods and operation processes are disclosed, but the protection scope of the present application is not limited to the following embodiments.

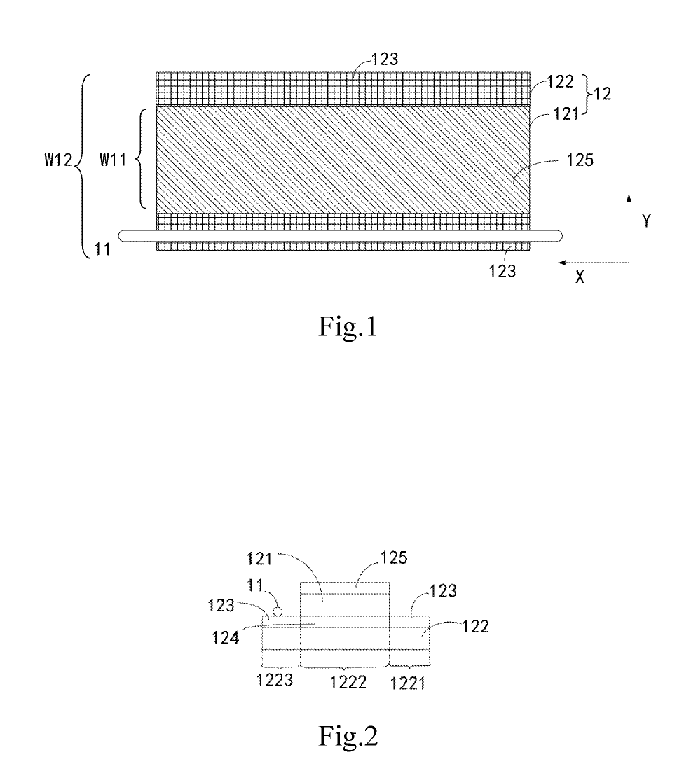

As shown in FIGS. 1-2, the winding wire of the present application comprises a wire 11 and an insulation structure 12, the wire 11 can be a substantially insulated solid wire or a substantially insulated strand wire, etc., the insulation structure 12 wraps around the wire 11. The insulation structure 12 comprises a first insulating layer 121 and a second insulating layer 122. The first insulating layer 121 has a first width W11, and the second insulating layer 122 has a second width W12, wherein the first width W11 is less than the second width W12. The second insulating layer 122 has an X-axis direction and a Y-axis direction perpendicular to the X-axis direction, and the first insulating layer 121 is disposed on the second insulating layer 122 in a direction parallel to the X-axis, and the wire 11 is disposed, in a direction parallel to the X-axis, on the portion of the second insulating layer 122 that is not covered by the first insulating layer 121. The first insulating layer 121 and the second insulating layer 122 wrap around the wire 11 in the Y-axis direction. For example, the number of insulating layers of the winding wire is at least three to meet the safety requirements, the number of insulating layers of the winding wire is at least three layers to meet the safety requirements. The number of insulating layers of the winding wire can be controlled by the first width W11 and/or the second width 12 and the location of the first insulating layer 121 on the second insulating layer 122. This processing method is simple, and the cost is also lower than the three-layer insulated Kara line.

Further, after the first insulating layer 121 bonded to the second insulating layer 122, the second insulating layer 122 is sequentially divided into a first fixed part 1221, an overlapping part 1222 and a second fixed part 1223 in the Y-axis direction, and the wire 11 is disposed on the second fixed part 1223 in the X-axis direction. The width of the first fixed part 1221 and/or the second fixed part 1223 may be greater than or equal to the perimeter of the wire 11, and the width of the overlapping part 1222 also may be greater than or equal to the perimeter of the wire 11. Specifically, the widths of the first fixed part 1221, the second fixed part 1223, and the overlapping part 1222 can be equal to the perimeter of the wire 11, and then the number of the insulating layers of the winding wire is exactly three, which is beneficial to further saving materials and reducing costs, and is easy to realize automatic processing.

Furthermore, the insulation structure 12 further comprises a first adhesive layer 123 and a second adhesive layer 124; the first adhesive layer 123 is disposed on the first fixed portion 1221 and/or the second fixed part 1223, the wire 11 is disposed on the first adhesive layer 123, and the first adhesive layer 123 is used to fix the wire more securely on the second insulating layer; the second adhesive layer 124 is disposed between the overlapping part 1222 and the first insulating layer 121 for bonding the first insulating layer 121 and the second insulating layer 122;

Wrapping around the wire 11 begins from the second fixed part 1223 provided with the wire 11 until bonded to the first fixed portion 1221. As shown in FIG. 2, the thicknesses of the first adhesive layer 123 and the second adhesive layer 124 can be controlled to the same.

In other embodiments, the wire 11 may also be disposed on the first fixed part 1221 in a direction parallel to the X-axis, and wrapping around the wire 11 begins from the first fixed part 1221 provided with the wire 11 until bonded to the second fixed part 1223.

The winding wire of the present application can be carried out in such a manner that the wire and the first insulating layer are contact directly with each other, so that it makes the insulation structure winding the wire more easily and smoothly to ensure that the processed wire surface is flat and compact, but the application is not limited to this.

Further, the insulation structure 12 comprises a third adhesive layer 125 disposed on the first insulating layer 121. Compared with the foregoing manner in which the wire and the first insulating layer are contact directly with each other, this manner allows the wire to be better fixed during winding process.

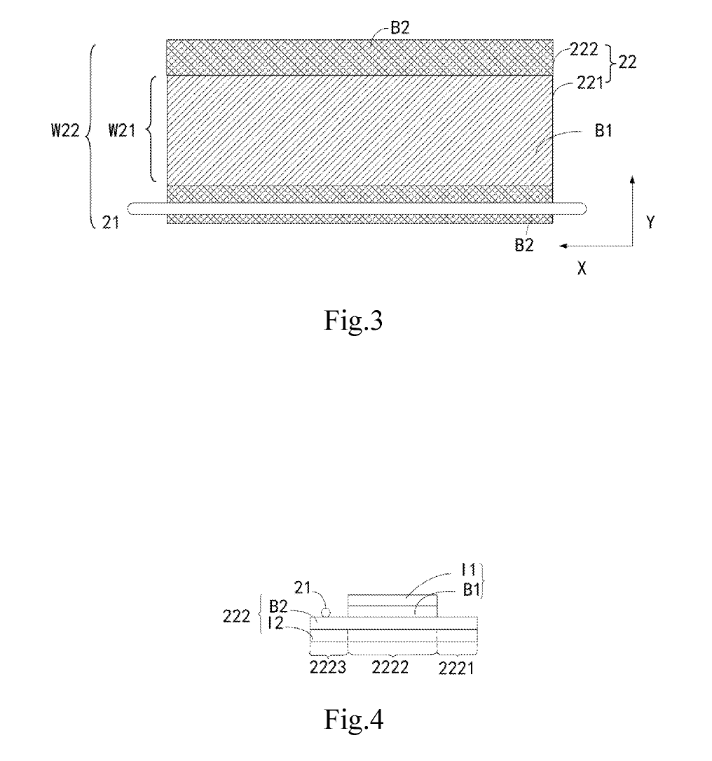

Referring to FIGS. 3-4, FIG. 3 is a top view of the structure of a second embodiment of the winding wire of the present application, and FIG. 4 is a side view of FIG. 3. The winding wire of the present application comprises a wire 21 and an insulation structure 22, the insulation structure 22 wraps around the wire 21, the wire 21 can be a substantially insulated solid wire or a substantially insulated strand wire, etc. The insulation structure 22 comprises a first insulating tape 221 and a second insulating tape 222. The first insulating tape 221 has a first width W21; the second insulating tape 222 has a second width W22, and the second insulating tape 222 has an X-axis direction and a Y-axis direction perpendicular to the X-axis direction. The first insulating tape 221 is bonded to the second insulating tape 222 in a direction parallel to the X-axis, and the first width W21 is less than the second width W22. The wire 21 is disposed, in a direction parallel to the X-axis, on the portion of the second insulating tape 222 that is not covered by the first insulating tape 221, and the first insulating tape 221 and the second insulating tape 222 wrap around the wire 21 in the Y-axis direction. The number of insulating layers of the winding wire is at least three to meet the safety requirements.

The first insulating tape 221 comprises a first backing layer B1 and a first insulating substrate layer I1 which are disposed opposite to each other, and the second insulating tape 222 comprises a second backing layer B2 and a second insulating substrate layer I2 which are disposed opposite to each other. The first backing layer B1 is bonded to the second backing layer B2. The second insulating substrate layer I2 of the second insulating tape 222 is divided into a first fixed part 2221, an overlapping part 2222 and a second fixed part 2223 sequentially in the Y-axis direction. In other words, the first insulating substrate layer I1 and the second insulating substrate layer I2 are the first insulating layer and the second insulating layer, respectively.

The wire 21 is disposed on the second fixed part 2223 in a direction parallel to the X-axis, and since there is the second backing layer B2 between the second fixed part 2223 and the wire, the wire can be fixed to the second insulating layer more securely before winding; When wrapping around the wire 21, the part of the first insulating tape that is in contact with the winding wire is the insulating substrate layer I1. Since the contact surface is a smooth, flat surface, the wire can be wound more easily and smoothly to ensure that the processed wire surface is flat and compact. Moreover, since the first fixed part 2221 also has the backing layer B2 thereon, it can be adhered to the second insulating substrate layer I2 more conveniently to finally complete the winding. In addition, the texture of the insulating tapes is relatively soft, so, when the winding wire is used for producing the windings of a transformer or another magnetic element, gaps between the winding wires can be reduced compared with the three-layer insulated Kara line, thereby further reducing the volume of the magnetic element and further enhancing the power density. Besides, the wire 21 can also be disposed on the first fixed part 2221 in a direction parallel to the X-axis, and wrapping around the wire 21 begins from the first fixed part 2221 provided with the wire 21 until bonded to the second fixed part 2223.

In another embodiment of the present application, the first insulating substrate layer I1 is bonded to the second backing layer B2, and the insulating substrate layer I2 of the second insulating tape 222 is divided into a first fixed part 2221, an overlapping part 2222, and a second fixed part 2223 sequentially.

The width of the first fixed part 2221 and/or the second fixed part 2223 may be greater than or equal to the perimeter of the wire 21, and the width of the overlapping part 2222 may also be greater than or equal to the perimeter of the wire 121. Specifically, the widths of the first fixed part 2221, the second fixed part 2223, and the overlapping part 2222 can be equal to the perimeter of the wire 21, and then the number of the insulating layers of the winding wire is exactly three, which is advantageous for the further saving of materials and costs, and which facilitates automatic processing.

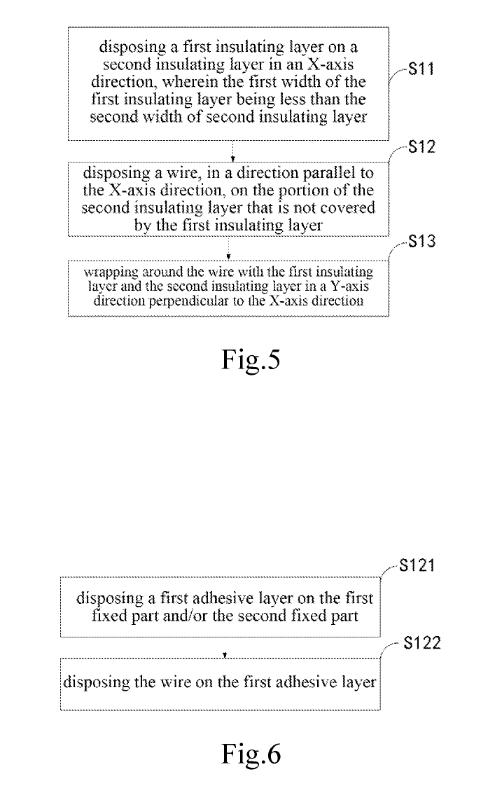

Referring to FIGS. 5-6, FIG. 5 is a flow chart of a method for producing the winding wire in FIG. 1, and FIG. 6 is a step-by-step flow chart of step S12 in FIG. 5. As shown in FIGS. 5-6, the method for producing a winding wire according to the present application comprises:

Step S11: disposing a first insulating layer on a second insulating layer in an X-axis direction, wherein the first width of the first insulating layer being less than the second width of second insulating layer. In an embodiment of the present application, after the first insulating layer is disposed on the second insulating layer, the second insulating layer is divided into a first fixed part, an overlapping part and a second fixed part sequentially in the Y-axis direction. The width of the first fixed part and/or the second fixed part may be greater than or equal to the perimeter of the wire, and the width of the overlapping part may be greater than or equal to the perimeter of the wire. Specifically, the widths of the first fixed part, the second fixed part and the overlapping part can be equal to the perimeter of the wire, and then the number of the insulating layers of the winding wire is exactly three, which is advantageous for the further saving of materials and costs, and which facilitates automatic processing. In another embodiment of the present application, after the first insulating layer disposed on the second insulating layer, the second insulating layer is divided into a first fixed portion and an overlapping portion in the Y-axis direction, but the present application is not limited to this.

Step S12: disposing a wire, in a direction parallel to the X-axis, on the portion of the second insulating layer that is not covered by the first insulating layer. In an embodiment of the present application, after the first insulating layer disposed on the second insulating layer, the second insulating layer is divided into a first fixed part, an overlapping part and a second fixed part sequentially in the Y-axis direction. The wire is disposed on the first fixed part or the second fixed part. The wire can be a substantially insulated solid wire or a substantially insulated strand wire, etc.

Step S13: wrapping around the wire with the first insulating layer and the second insulating layer in a Y-axis direction perpendicular to the X-axis direction, wherein wrapping around the wire begins from the first fixed part provided with the wire to the second fixed part; or wrapping around the wire begins from the second fixed part provided with the wire to the first fixed part.

Further, Step S12 further comprises:

Step S121: disposing a first adhesive layer on the first fixed part and/or the second fixed part; and

Step S122: disposing the wire on the first adhesive layer.

Further, disposing a second adhesive layer between the overlapping part and the first insulating layer in Step S11, and/or further disposing a third adhesive layer on the first insulating layer in Step S11.

Furthermore, the first insulating layer and the second insulating layer wrap around the wire until the number of insulating layers of the winding wire is at least three.

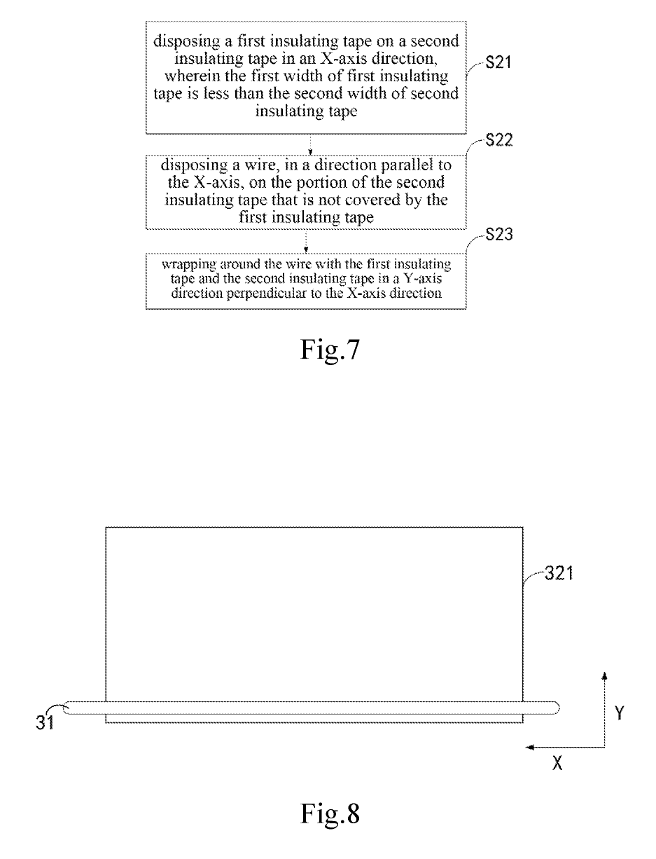

Referring to FIG. 7, which is a flow chart of a method for producing the winding wire in FIG. 3. As shown in FIG. 7, the method for producing a winding wire according to the present application comprises:

Step S21: disposing a first insulating tape on a second insulating tape in an X-axis direction, wherein the first width of first insulating tape is less than the second width of second insulating tape;

Step S22: disposing a wire, in a direction parallel to the X-axis, on the portion of the second insulating tape that is not covered by the first insulating tape, the wire being a substantially insulated solid wire or a substantially insulated strand wire; and

Step S23: wrapping around the wire with the first insulating tape and the second insulating tape in a Y-axis direction perpendicular to the X-axis direction.

Furthermore, in Step 21, the first insulating tape comprises a first backing layer and a first insulating substrate layer which are disposed opposite to each other, and the second insulating tape comprises a second backing layer and a second insulating substrate layer which are disposed opposite to each other; in step 21, the first backing layer is bonded to the second backing layer, i.e., the first insulating tape is bonded to the second insulating tape to divide the second insulating substrate layer I2 of the second insulating tape 222 into a first fixed part 2221, an overlapping part 2222 and a second fixed part 2223 sequentially in the Y-axis direction. In other words, the first insulating substrate layer and the second insulating substrate layer are the first insulating layer and the second insulating layer, respectively.

Moreover, in Step S22, the wire is disposed on the second fixed part in a direction parallel to the X-axis. Since there is a second backing layer between the second fixed part and the wire, the wire can be fixed to the second insulating layer more securely before winding; In Step S23, the first insulating tape and the second insulating tape wrapping around the wire begins from the second fixed part provided with the wire to the first fixed part. The contact part of the first insulating tape with the winding wire is an insulating substrate layer which is a smooth, flat surface, so it is easier to wind the wire smoothly to ensure that the processed wire surface is flat and compact. Moreover, since the first fixed part also has the backing layer thereon, it can be adhered to the second insulating substrate layer more conveniently to complete the winding and obtain a winding wire comprising insulating layers.

In other embodiments, the wire can also be disposed on the first fixed part in a direction parallel to the X-axis, and wrapping around the wire begins from the first fixed part provided with the wire until bonded to the second fixed part.

According to other aspects of the present application, the first insulating substrate layer is bonded to the second backing layer to divide the insulating substrate layer I2 of the second insulating tape into a first fixed part, an overlapping part and a second fixed part sequentially.

Further, the width of the first fixed part 2221 and/or the second fixed part 2223 can be greater than or equal to the perimeter of the wire 21, and the width of the overlapping part 2222 can be greater than or equal to the perimeter of the wire 21. When the widths of the first fixed part 2221, the second fixed part 2223 and the overlapping part 2222 are all equal to the perimeter of the wire 21, the number of the insulating layers of the winding wire is exactly three, which is advantageous for the further saving of materials and costs, and which facilitates automatic processing.

Referring to FIG. 8, the winding wire of the present application comprises a wire 31 and a first insulating layer 321, wherein the wire 31 is a substantially insulated solid wire or a substantially insulated strand wire. The first insulating layer 321 has an X-axis direction and a Y-axis direction perpendicular to the X-axis direction. The wire 31 is disposed on the first insulating layer 321 in the X-axis direction, and the first insulating layer 321 wraps around the wire 31 in the Y-axis direction.

By setting the width of the first insulating layer 321, the number of insulating layers of the winding wire can be at least three after the first insulating layer 321 wraps around the wire 31. For example, the first insulating layer 321 is the insulating substrate layer of an insulating tape, and the wire 31 is disposed on the first insulating layer 321 in a direction parallel to the X-axis, wherein the backing layer of insulating tape is between the wire 31 and the first insulating layer 321.

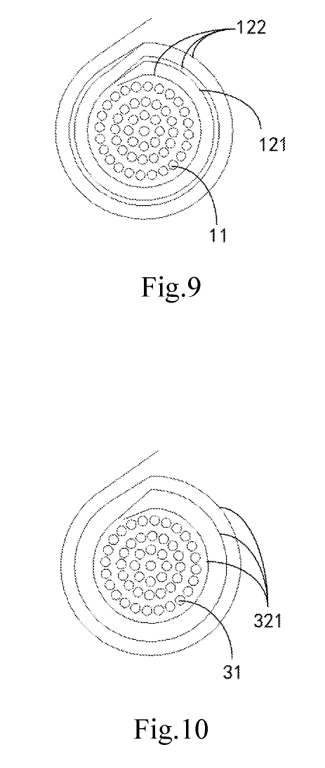

Referring to FIGS. 1 and 9, the first insulating layer 121 and the second insulating layer 122 wrap around the wire 11 until the number of insulating layers of the winding wire is at least three.

Referring to FIGS. 8 and 10, the first insulating layer 321 wraps around the wire 31 until the number of insulating layers of the winding wire is at least three.

The present application further discloses a winding of a magnetic element, comprising the winding wire shown in FIG. 1 or FIG. 3 or FIG. 8 as described above, that is, the winding is produced from said winding wire.

In view of the above, by means of the winding wire of the present application and the production method thereof, it is easy to achieve automatic processing and wind the wire more smoothly, which ensures that the processed wire surface is flat and compact, the power density of magnetic elements is increased, and costs are reduced while reinforcing insulation.

Finally, the above embodiments are merely meant to illustrate rather than limit the technical solutions described in the present application; moreover, although the present application is described in detail with reference to the above embodiments in this specification, the ordinary persons skilled in the art should understand that modifications or equivalent substitutions can still be made to part or all of the present application; thus, all the technical solutions not departing from the spirit and scope of the present application and the improvements thereof should be covered by the protection scope of the appended claims of the present application.

What is claimed is:

1. A winding wire, comprising:
a wire; and
an insulation structure wrapping around the wire, and the insulation structure further comprising:
a first insulating layer having a first width; and
a second insulating layer having a second width,
wherein the second insulating layer has an X-axis direction and a Y-axis direction perpendicular to the X-axis direction, the first insulating layer is disposed on the second insulating layer in a direction parallel to the X-axis, the first width is less than the second width, the wire is disposed, in a direction parallel to the X-axis, on the portion of the second insulating layer that is not covered by the first insulating layer, and the first insulating layer and the second insulating layer wrap around the wire along the Y-axis direction.

2. The winding wire according to claim 1, wherein the first insulating layer is disposed on the second insulating layer to divide the second insulating layer into a first fixed part, an overlapping part and a second fixed part sequentially in the Y-axis direction, and the wire is disposed on the first fixed part or the second fixed part.

3. The winding wire according to claim 2, wherein at least one of the width of the first fixed part and the second fixed part is greater than or equal to the perimeter of the wire.

4. The winding wire according to claim 2, wherein the width of the overlapping part is greater than or equal to the perimeter of the wire.

5. The winding wire according to claim 1, wherein the first insulating layer and the second insulating layer wrap around the wire until the number of insulating layers of the winding wire is at least three.

6. The winding wire according to claim 1, wherein the wire is a substantially insulated solid wire or a substantially insulated strand wire.

7. The winding wire according to claim 2, wherein the insulation structure further comprises a first adhesive layer, and the first adhesive layer is disposed on at least one of the first fixed part and the second fixed part, and the wire is disposed on the first adhesive layer.

8. The winding wire according to claim 7, wherein the insulation structure further comprises a second adhesive layer disposed between the overlapping part and the first insulating layer.

9. The winding wire according to claim 7, wherein the insulation structure further comprises a third adhesive layer disposed on the first insulating layer.

10. The winding wire according to claim 2, wherein the first insulating layer is a first insulating substrate layer of a first insulating tape, and the second insulating layer is a second insulating substrate layer of a second insulating tape.

11. The winding wire according to claim 10, wherein the first insulating tape further comprises a first backing layer opposite to the first insulating substrate layer, and the second insulating tape further comprises a second backing layer opposite to the second insulating substrate layer.

12. The winding wire according to claim 11, wherein the first backing layer is bonded to the second backing layer.

13. The winding wire according to claim 11, wherein the first insulating substrate layer is bonded to the second backing layer.

14. The winding wire according to claim 11, wherein the wire is disposed on the first fixed part, and the second backing layer is between the first fixed part and the wire.

15. The winding wire according to claim 11, wherein the wire is disposed on the second fixed part, and the second backing layer is between the second fixed part and the wire.

16. A method for producing a winding wire, comprising:
disposing a first insulating layer on a second insulating layer in an X-axis direction, wherein the first insulating layer has a first width, the second insulating layer has a second width, and the first width is less than the second width;
disposing a wire, in a direction parallel to the X-axis, on the portion of the second insulating layer that is not covered by the first insulating layer; and
wrapping around the wire with the first insulating layer and the second insulating layer in a Y-axis direction perpendicular to the X-axis direction.

17. The method according to claim 16, wherein the first insulating layer is disposed on the second insulating layer to divide the second insulating layer into a first fixed part, an overlapping part and a second fixed part sequentially in the Y-axis direction.

18. The method according to claim 17, wherein the wire is disposed on the first fixed part or the second fixed part.

19. The method according to claim 17, wherein at least one of the width of the first fixed part and the second fixed part is greater than or equal to the perimeter of the wire.

20. The method according to claim 17, wherein the width of the overlapping part is greater than or equal to the perimeter of the wire.

21. The method according to claim 16, wherein wrapping around the wire with the first insulating layer and the second insulating layer until the number of insulating layers of the winding wire is at least three, and the wire is a substantially insulated solid wire or a substantially insulated strand wire.

22. The method according to claim 17, wherein the step of disposing the wire on the portion of the second insulating layer further comprises:
disposing a first adhesive layer on at least one of the first fixed part and the second fixed part; and
disposing the wire on the first adhesive layer.

23. The method according to claim 17, wherein a second adhesive layer is disposed between the overlapping part and the first insulating layer.

24. The method according to claim 17, wherein the first insulating layer is a first insulating substrate layer of a first insulating tape, and the second insulating layer is a second insulating substrate layer of a second insulating tape.

25. The method according to claim 24, wherein the first insulating tape further comprises a first backing layer opposite to the first insulating substrate layer, and the second insulating tape further comprises a second backing layer opposite to the second insulating substrate layer, wherein the second backing layer is bonded to the first backing layer or the first insulating substrate layer.

26. The method according to claim 25, wherein the wire is disposed on the first fixed part, and the second backing layer is between the first fixed part and the wire;

27. The method according to claim 25, wherein the wire is disposed on the second fixed part, and the second backing layer is between the second fixed part and the wire.

28. The method according to claim 22, wherein, wrapping around the wire begins from the first fixed part provided with the wire to the second fixed part; or wrapping around the wire begins from the second fixed part provided with the wire to the first fixed part.

29. A winding wire, comprising a wire and a first insulating layer, wherein the first insulating layer having an X-axis direction and a Y-axis direction perpendicular to the X-axis direction, the wire being disposed on the first insulating layer in the X-axis direction, and the first insulating layer wrapping around the wire in the Y-axis direction.

30. The winding wire according to claim 29, wherein the first insulating layer wraps around the wire until the number of insulating layers of the winding wire is at least three, and the wire is a substantially insulated solid wire or a substantially insulated strand wire.

31. A winding of a magnetic element, comprising the winding wire according to claim 1.

32. A winding of a magnetic element, comprising the winding wire according to claim 29.
